(19) United States
(12) Patent Application Publication
(10) Pub. No.: US 2015/0035983 A1
(43) Pub. Date: Feb. 5, 2015

(54) METHOD AND VEHICLE ASSISTANCE SYSTEM FOR ACTIVE WARNING AND/OR FOR NAVIGATION ASSISTANCE TO PREVENT A COLLOSION OF A VEHICLE BODY PART AND/OR OF A VEHICLE WHEEL WITH AN OBJECT

(71) Applicant: ROBERT BOSCH GMBH, Stuttgart (DE)

(72) Inventor: Volker Niemz, Rutesheim (DE)

(21) Appl. No.: 14/362,654

(22) PCT Filed: Nov. 16, 2012
(86) PCT No.: PCT/EP2012/072873

§ 371 Date: Jun. 4, 2014

(30) Foreign Application Priority Data
Dec. 7, 2011 (DE) 10 2011 087 897.7

(51) Int. Cl. B60R 21/0134; G06T 7/00; B60Q 9/00; G06K 9/00; B60R 1/00; B60R 11/04

(52) U.S. Cl. CPC B60R 21/0134; B60R 1/00; B60R 11/04; B60Q 9/008; G06K 9/00805; G06T 7/0022; B60R 2300/806; B60R 2300/8093; B60R 2021/01013
USPC 348/148

(57) ABSTRACT

A method for active warning and/or for navigation assistance to prevent a collision of a vehicle body part and/or of a vehicle wheel with at least one curb and/or another similar object, the at least one object being recognized based on an evaluation of the images of the vehicle surroundings recorded with the aid of at least one camera situated on the vehicle, and an active warning being issued and/or an active intervention in the vehicle dynamics being carried out when a possible collision exists between a vehicle body part and/or a vehicle wheel and the at least one recognized object.

### FIELD

The present invention relates to a method for active warning and/or for navigation assistance to prevent a collision of a vehicle body part and/or of a vehicle wheel with at least one curb and/or another similar object and to a vehicle assistance system for carrying out the method according to the present invention. The present invention also relates to a vehicle having a vehicle assistance system according to the present invention.

### BACKGROUND INFORMATION

A number of pure backup camera systems exist in the market. These have the task of providing the driver with a real image of the condition behind the vehicle.

In addition to these systems, multicamera systems are increasingly penetrating the market. These allow the vehicle surroundings to be depicted from a bird's eye view (top view).

In the future, it will no longer suffice to depict only the immediate vehicle surroundings, but the market is demanding systems which support the driver in the use of the vehicle in diverse situations.

The area laterally around the vehicle is sufficiently detectable with the aid of cameras mounted laterally on the vehicle, in particular on the wheel housing edge or in the mirror housing.

FIG. 1 shows a top view onto a vehicle (car) 10 having a multicamera system 20 with a typical configuration which is known from the related art.

The area laterally around vehicle 10 is sufficiently detectable with the aid of cameras 40, 50 mounted laterally on vehicle 10, in particular on the wheel housing edge or in mirror housing 45, 55. Additional cameras, such as a front camera 30 and a rear view camera 60, may be present on the vehicle. FIG. 1 also shows wheels 70, 80, 90, 100 of vehicle 10.

FIG. 2 shows a partial side view of the vehicle of FIG. 1 with the corresponding multicamera system 20. While the vehicle is driving on a road 110, the immediate area 111 laterally around vehicle 10 (approximately 1 m) is constantly analyzed for the presence of a curb. This is achieved in a simple manner, for example, with the aid of the evaluation of the detected gradients (gradient recognition, e.g., with the aid of the Sobel operator). These are then compared with the aid of appropriately defined classifiers.

The position of the recognized curb may now be compared to the instantaneous vehicle speed. Should the rear wheel (in the case of driving forward) or the front wheel (in the case of backing up) collide with a curb, the driver is to be given a timely warning.

It is also possible that a jerky steering motion is exerted in the driving setpoint direction to prevent a corresponding collision.

FIG. 3 shows a typical result of a curb collision. The deformed vehicle wheel 80 and curb 120 are apparent therein.

Curb collisions occur very frequently, in particular when sharp or tight curves are present. FIGS. 4a, 4b and 4c show three different positions of vehicle 10 of FIG. 1 as it drives in a tight curve which occurs at the end of a road 110. The driver is taking the curve with too tight a radius. Front wheel 80 passes the curve; rear wheel 90 collides with curb 120. Rear wheel (tire, rim) 90 could sustain considerable damage, and the driving comfort could also be considerably impaired as a result.

Navigation assistant systems to prevent curb collisions are described, for example, in German Patent Application Nos. DE 10 2005 037 273 A1 and DE 10 2005 015 463 B4, which operate in a camera-based manner and identify curbs based on object recognition. Here, however, only pattern recognition exists in general, in which the detected objects are compared to previously known stored patterns. The drawback is that the conventional navigation assistant systems must have sufficient memory space for storing the plurality of previously known patterns and/or must have high computing power so that in particular the comparison time to the many existing patterns is short enough to be able to respond suitably quickly in a dangerous situation.

### SUMMARY

In an example method according to the present invention for active warning and/or for navigation assistance to prevent a collision of a vehicle body part and/or of a vehicle wheel with at least one curb and/or another similar object, the at least one object is recognized based on an evaluation of the images of the vehicle surroundings recorded with the aid of at least one camera situated on the vehicle. Moreover, if a possible collision exists between a vehicle body part and/or a vehicle wheel and the at least one recognized object, an active warning is issued and/or an active intervention in the vehicle dynamics, in particular in the steering, is carried out. In the example method according to the present invention, the pattern of the instantaneously surrounding road is determined with the aid of an evaluation of at least one image of the vehicle surroundings recorded with the aid of at least one camera situated on the vehicle, and at least one image of the vehicle surroundings recorded with the aid of at least one camera situated laterally on the vehicle is evaluated for differences from the determined pattern of the instantaneously surrounding road in order to recognize the at least one object.

According to an example embodiment of the present invention, additionally a vehicle assistance system for carrying out the method according to the present invention is provided, which includes an evaluation unit which is designed to determine at least one curb and/or another similar object based on an evaluation of at least one image of the vehicle surroundings recorded with the aid of at least one camera, which in particular is situated laterally on the vehicle, the evaluation including a pattern recognition of the instantaneously surrounding road, and to generate a warning signal and/or a control signal when a possible collision exists between a vehicle body part and/or a vehicle wheel with the at least one determined object. The vehicle assistance system according to the present invention further includes a warning unit, which is designed to issue an active warning when a warning signal generated by the evaluation unit is present, and/or a control unit, which is designed to actively intervene in the vehicle dynamics, in particular in the steering, when a control signal generated by the evaluation unit is present.

According to an example embodiment of the present invention, an active warning and/or a navigation assistance to prevent wheel or tire contact with a curb and/or similar objects is/are provided in a simple manner. In the example method according to the present invention, the pattern of the present road is determined based on an evaluation of images of the vehicle surroundings. Based on a comparison to the pattern of the presently surrounding road, images of an area of the vehicle surroundings extending laterally from the vehicle are analyzed for the presence of obstacles situated laterally from the vehicle, such as curbs and/or similar objects. According to the present invention, an example method for recognizing obstacles, such as curbs and/or similar objects, is used which requires little computing and is thus quick to carry out. In the example method according to the present invention, the time-consuming and computing-intensive comparison to many previously known patterns for the recognition of obstacles is dispensed with. In addition, the determination of the pattern of the presently surrounding road according to the present invention dispenses with the computing-intensive and time-consuming evaluation of multiple consecutively recorded images of the vehicle surroundings, which depict at least one section of the road to be driven.

A vehicle assistance system for carrying out the example method according to the present invention does not need relevant additional modules having high computing power. Since at least one camera and an evaluation unit are present in a conventional vehicle assistance system, in general no additional systems for carrying out the recognition of obstacles according to the present invention must be provided either.

In the example method according to the present invention, at least one image of a road section is advantageously recorded with the aid of a front and/or rear view camera situated on the vehicle for determination of the patterns of the presently surrounding road and is correlated with at least one image of the vehicle surroundings recorded with the aid of the at least one lateral camera for recognition of the at least one object.

It is analyzed in the example method according to the present invention whether the pixels close to the wheel correspond to the image of the road or an obstacle. In the case of a front and/or rear view camera (backup camera), it may initially be checked whether an obstacle is situated in the immediate surroundings. This may be done with the aid of a park pilot or by using video sensors. If no object was recognized, the image area directly behind or in front of the bumper may be stored into a memory unit as a representative pattern for the surrounding road. The stored image of the road section may now be correlated with the image from the lateral camera. This may necessitate a histogram adaptation due to different lighting situations. As a result of this step, the pattern of the instantaneously surrounding road is known, and the image section in the vicinity of the wheel may be evaluated for a significant difference from the particular road pattern. Differences from the particular road pattern are established precisely when no road, but a curb or another obstacle, is depicted in the image.

In one further advantageous specific embodiment of the present invention, the pattern of the presently surrounding road is determined in a simple manner with the aid of a recognition of relevant structure repetitions in at least one image of the vehicle surroundings recorded with the aid of at least one camera, in particular one situated laterally on the vehicle.

Instead of the pattern comparison of the images from the front and/or rear view camera to the images from the lateral camera, the road may also be recognized in a simple manner via a relevant structure repetition.

During the recognition of the pattern of the instantaneously surrounding road according to the present invention, in particular at least one predefined image section of an image of the vehicle surroundings recorded with the aid of the at least one lateral camera is evaluated, the predefined image section depicting the direct area of the vehicle surroundings marginally in front of and/or next to a vehicle part, in particular adjoining a vehicle part, in particular marginally in front of the side skirt.

The example method according to the present invention for recognizing the ground pattern using the direct image section marginally in front of the side skirt, the side skirt also being recognized by the camera and the body being viewable as a result of the mirrors attached to the vehicle, may be carried out very easily and quickly.

In this way, an automated parking system may already have knowledge of the position of the curb.

During the determination of the at least one object according to the present invention, preferably object recognition and/or object tracking with the aid of an evaluation of images of the vehicle surroundings is/are additionally used, the images being recorded with the aid of at least one camera situated on the vehicle.

In the example method according to the present invention, tracking of objects which are recognized by a forwardly directed camera may be carried out. In addition or as an alternative, in particular objects which are also recognized by a rear view camera are used, which may be forwardly extrapolated, in particular in the case of a recognized road or of an obstacle extending along the road. Extrapolation assistance using GPS is also possible. The extrapolation length in this case is dependent on the depiction of the instantaneous vehicle surroundings on the GPS map. If an immediately upcoming driveway or a sharp curve exists, the rear image may only be extrapolated very little; in the case of a straight road, however, further extrapolation is possible. This increases the detection probability for a curb since the structure of the vehicle surroundings is analyzed in greater detail.

According to the present invention, additionally a height of the at least one object is determined in particular with the aid of an evaluation of at least one image of the vehicle surroundings which is recorded in particular with the aid of a stereo camera and/or a line scan camera situated on the vehicle. In this way the detection probability for a curb may be increased since an additional feature is available.

In one particularly preferred specific embodiment of the present invention, at least one object recognized as an obstacle, in particular at least one curb recognized as an obstacle, is supplied to a classifier as a pattern for recognizing similar obstacles.

According to the present invention, classifiers are trained. During an automated parking attempt with the aid of a parking steering control unit, the vehicle automatically aligns itself with a curb in a longitudinal parking space. The system thus already knows the position and the presence of a curb. This information may be used directly by the image-processing algorithm and relevant objects in the image may be automatically supplied to the classifier, which corresponds to an autolearning function of the classifier for curb representations in the image.

The classifier may further learn as a result of negative experiences. Should the vehicle run over an obstacle which was not classified as a dangerous object, relevant jerky movements of the body and wheels result. These may be recognized with the aid of different sensors (tire pressure sensor, level sensors, sensors for longitudinal and transverse acceleration and/or yaw rate).

The classifier may thus in particular be supplied with information about obstacles which are situated in presently very frequently traveled surroundings. When using an appropriately trained classifier, a detected obstacle from such frequently traveled surroundings only has to be compared to a small number of patterns present in the classifier which correspond to the obstacles of these particular surroundings. This considerably reduces the computing complexity associated with the comparison algorithm and, as a result, also the corresponding comparison time.

In addition, a vehicle having an example vehicle assistance system according to the present invention is provided according to the present invention.

The advantages of the example vehicle assistance system according to the present invention and of the vehicle according to the present invention generally correspond to the advantages of the corresponding method according to the present invention. Repetition is therefore dispensed with.

### BRIEF DESCRIPTION OF THE DRAWINGS

Exemplary embodiments of the present invention are described in greater detail below with reference to the figures.

FIG. 1 shows a top view onto a vehicle having a multicamera system according to the related art.

FIG. 2 shows a side view of the vehicle of FIG. 1 having the corresponding multicamera system according to the related art.

FIG. 3 shows an image of a wheel of a vehicle during a curb collision.

FIGS. 4a through 4c show top views onto the vehicle of FIG. 1 having the multicamera system according to the related art in three different positions as the vehicle is taking a tight curve.

FIG. 5 shows a top view onto a vehicle having a vehicle assistance system according to the present invention according to a first specific embodiment of the present invention.

FIG. 6 shows a side view of a vehicle having a vehicle assistance system according to the present invention according to a second specific embodiment of the present invention.

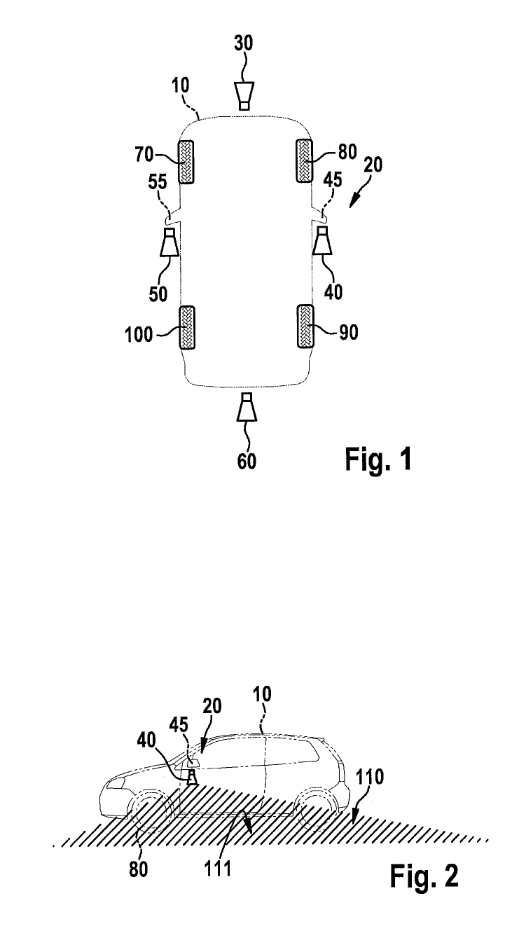

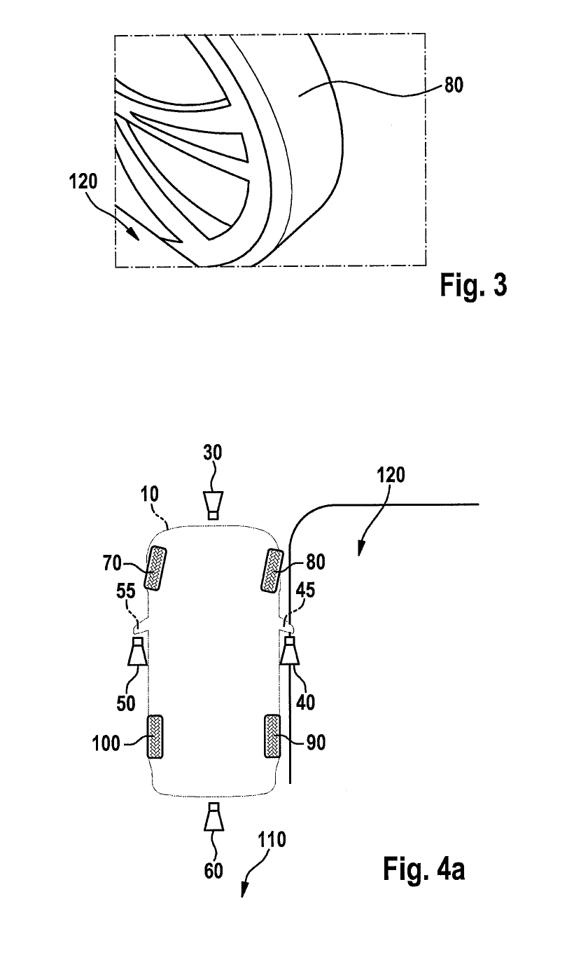

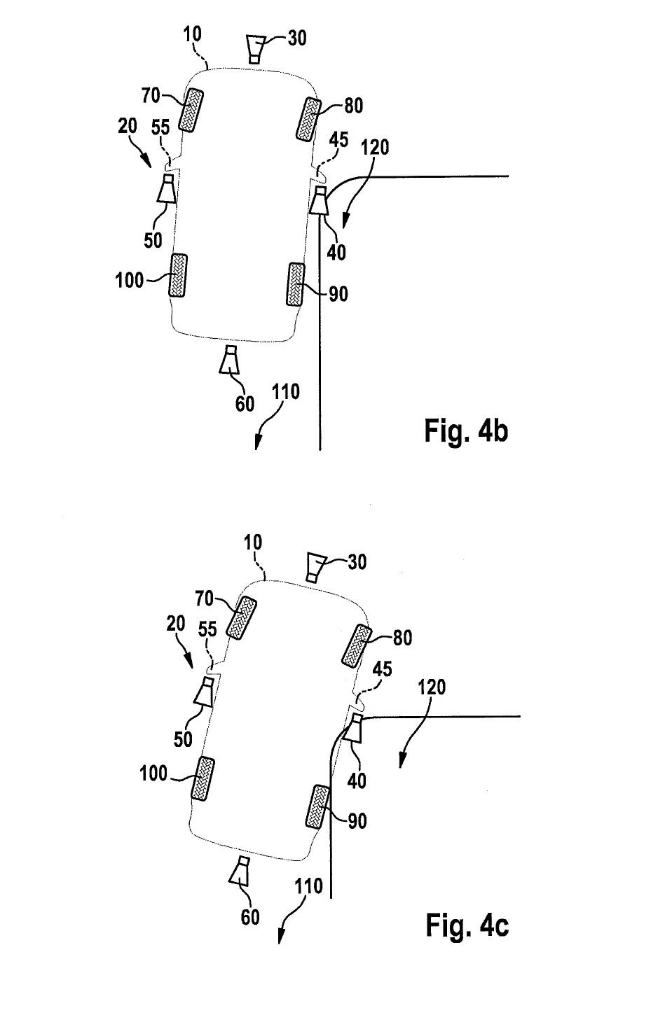

### DETAILED DESCRIPTION OF EXAMPLE EMBODIMENTS

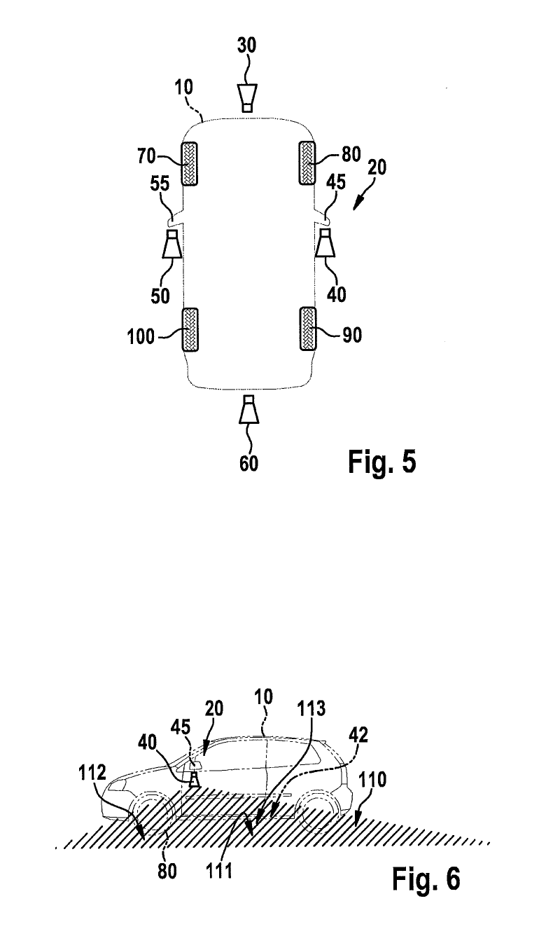

FIG. 5 shows a top view onto a vehicle 10 having a vehicle assistance system 20 according to the present invention according to a first specific embodiment of the present invention.

The lateral area of vehicle 10 is sufficiently detectable with the aid of cameras 40, 50 mounted laterally on vehicle 10, in particular on the wheel housing edge or in mirror housing 45, 55. Additional cameras, such as a front camera 30 and a rear view camera 60, may be present on vehicle 10. FIG. 5 also shows wheels 70, 80, 90, 100 of vehicle 10. In vehicle assistance system 20 according to the present invention for active warning and/or for navigation assistance to prevent a collision of a vehicle wheel 70, 80, 90, 100 with a curb and/or similar objects, it is checked with the aid of cameras 30, 40, 50, 60 situated on vehicle 10 whether a curb is recognized. With the aid of vehicle assistance system 20 according to the present invention, a warning is issued to the driver and/or an active intervention in the steering is carried out if a possible collision exists. In vehicle assistance system 20 according to the present invention according to the first specific embodiment of the present invention, the object recognition is carried out in particular using pattern recognition by recording a road section, via a front camera 30 and/or a rear view camera, which is correlated with the image of a lateral camera 40, 50 to recognize a curb or another obstacle.

FIG. 2 shows a side view of a vehicle 10 having a vehicle assistance system 20 according to the present invention according to a second specific embodiment of the present invention. While the vehicle is driving on a road 110, the immediate area 111 laterally around vehicle 10 is constantly analyzed for the presence of a curb. A recognition of the pattern of the presently surrounding road is possible via a recognition of relevant structure repetitions. It is also possible to use the direct image section which depicts area 112 of the vehicle surroundings in the vicinity of a vehicle part, in particular of a wheel 80, and/or area 113 of the vehicle surroundings marginally in front of side skirt 42.

In addition to the above description, reference is hereby made to the representation in FIGS. 5 and 6 on a supplementary basis for the additional disclosure of the present invention.

1-10. (canceled)

11. A method for at least one of active warning and for navigation assistance to prevent a collision of at least one of a vehicle body part and of a vehicle wheel with an object, the method comprising:
determining a pattern of an instantaneously surrounding road by an evaluation of an image recorded with the aid of at least one camera situated on the vehicle;
evaluating an image recorded with the aid of at least one camera situated laterally on the vehicle for differences from a certain pattern of the instantaneously surrounding road for recognition of the object; and
at least one of: i) issuing a warning to a driver, and ii) carrying out an active intervention in vehicle dynamics, if a possible collision exists between the at least one of the vehicle body part and the vehicle wheel, and the recognized object.

12. The method as recited in claim 11, wherein the object is a curb.

13. The method as recited in claim 11, wherein at least one image of a road section is recorded with the aid of at least one of a front camera and a rear view camera, situated on the vehicle for the determination of the pattern of the instantaneously surrounding road and is correlated with the at least one image of the vehicle surroundings recorded with the aid of the at least one lateral camera for the recognition of the at least one object.

14. The method as recited in claim 11, wherein the pattern of the instantaneously surrounding road is determined with the aid of an evaluation of at least one image of the vehicle surroundings recorded with the aid of at least one camera situated laterally on the vehicle for the recognition of relevant structure repetitions.

15. The method as recited in claim 11, wherein a direct area of the vehicle surroundings marginally in front of a side skirt of the vehicle in a predefined image section of an image from the lateral camera is evaluated during the recognition of the pattern.

16. The method as recited in claim 11, wherein during the recognizing of the at least one object, at least one of object recognition and object tracking, is carried out with the aid of an evaluation of camera images of the vehicle surroundings.

17. The method as recited in claim 11, wherein during the recognizing of the at least one object, a height of the at least one object is recorded with a camera, the camera being one of a stereo camera or a line scan camera.

18. The method as recited in claim 11, wherein at least one object recognized as an obstacle is supplied to a classifier as a pattern for the recognition of similar obstacles.

19. The method as recited in claim 18, wherein the obstacle is a curb.

20. A vehicle assistance system comprising:
an evaluation unit which is designed to determine at least one object, based on an evaluation of at least one image of the vehicle surroundings recorded with the aid of at least one camera which is situated laterally on the vehicle, the evaluation including a pattern recognition of an instantaneously surrounding road, and to generate at least one of a warning signal and a control signal when a possible collision exists between at least one of a vehicle body part and a vehicle wheel, with the at least one recognized object; and
at least one of i) a warning unit which is designed to issue an active warning when a warning signal generated by the evaluation unit is present, and ii) a control unit, which is designed to actively intervene in vehicle dynamics when a control signal generated by the evaluation unit is present.

21. The vehicle assistance system as recited in claim 20, wherein the evaluation unit is further designed to at least one of: i) carry out object recognition, and ii) carry out object tracking, for the determination of the at least one object with the aid of an evaluation of camera images.

22. The vehicle assistance system as recited in claim 20, wherein the evaluation unit is designed to determine a height to the at least one recognized object with the aid of an evaluation of at least one image of the vehicle surroundings, which was recorded using at least one of a stereo camera and a line scan camera.

23. The vehicle assistance system as recited in claim 20, wherein the evaluation unit is designed to classify at least one detected object with the aid of a classifier and to supply at least one object recognized as an obstacle to the classifier as a pattern for the recognition of similar obstacles.

24. The vehicle assistance system as recited in claim 23, wherein the obstacle is a curb.

25. A vehicle, comprising:
a vehicle assistance system including an evaluation unit which is designed to determine at least one object, based on an evaluation of at least one image of the vehicle surroundings recorded with the aid of at least one camera which is situated laterally on the vehicle, the evaluation including a pattern recognition of an instantaneously surrounding road, and to generate at least one of a warning signal and a control signal when a possible collision exists between at least one of a vehicle body part and a vehicle wheel, with the at least one recognized object, and at least one of i) a warning unit which is designed to issue an active warning when a warning signal generated by the evaluation unit is present, and ii) a control unit, which is designed to actively intervene in vehicle dynamics when a control signal generated by the evaluation unit is present.
